(19) United States
(12) Patent Application Publication
(10) Pub. No.: US 2023/0377074 A1
(43) Pub. Date: Nov. 23, 2023

(54) Quantifying Innovation and a Standardized and Data-Driven Approach to Determine the Value of Intangible Innovation Assets

(71) Applicants: Jonas Block, Dusseldorf (DE); Luis Soriano Valdes, Madrid (ES); Erich Lawson Spangenberg, Paris (FR)

(72) Inventors: Jonas Block, Dusseldorf (DE); Luis Soriano Valdes, Madrid (ES); Erich Lawson Spangenberg, Paris (FR)

(21) Appl. No.: 18/116,281

(22) Filed: Mar. 1, 2023

Related U.S. Application Data
(63) Continuation of application No. 63/315,462, filed on Mar. 1, 2022.

(51) Int. Cl. G06Q 50/18

(52) U.S. Cl. CPC G06Q 50/184

(57) ABSTRACT

Patents are important innovation assets and can provide an array of insights into their owners' resilience towards changing markets, and their owners' potential to build and maintain competitive edges on the current markets. Yet, patents do not play an important role on the company balance sheet. In fact, the value of the vast majority of patents is never assessed. With growing global rates for intangible value, the minimum value encompassed in patents needs to be revealed to make patent value and patent positions quantifiable. This paper discusses a novel and fully automated income-based valuation approach for the world's patents, aiming to serve as a quick, robust, standardized and scalable benchmark for financial analysis. The approach leverages exponential technologies to safeguard that all patents are undergoing the same degree of review even if millions of documents are assessed in parallel.

### CROSS REFERENCE TO RELATED APPLICATIONS

This application claims the benefit of U.S. Provisional Patent Application Ser. No. 63/315,462, filed on Mar. 1, 2022, the contents of which are also incorporated herein by reference.

### BACKGROUND OF THE INVENTION

Innovation is key to business success. Innovative enterprises benefit from enhanced flexibility—making them more adaptive to changing market conditions and to exploiting new ideas. As such, innovation fosters resilience and helps build competitive edges, two key corporate characteristics that executives, investors, and financial analysts are looking for in a company. Because of its fundamental importance, a lot of research has focused on how to measure a corporation's potential to innovate, and how innovation potential correlates with business success.

While there is consensus between researchers that innovation materializes in many different ways, the individual approaches vary significantly when it comes to the measurement of innovation and innovation potential. In practice, the most pragmatic approach is to seek for innovation indicators on the corporate balance sheet as the balance sheet is front and center when it comes to measuring corporate performance and success from the perspective of the financial world and the corporate accounting division. Or put the other way around: If a contribution to corporate success is not reflected in a quantifiable way on the balance sheet, then this contribution is not included in the company valuation.

The quantified innovation potential does not represent a prominent category on the balance sheet. Instead, it usually—and if at all—ekes out a very vague and undefined existence in the category of intangible assets. At the same time it is established that economies that are experiencing growth in intangibles investment are also posting growth in total factor productivity, and that IP and other intangibles add twice as much value to products as tangible capital. This disconnect between the perception of overall corporate value and balance sheets drawn up under traditional accounting rules is increasingly criticized for understating the importance of intangible assets.

Innovation assets, can be described as corporate assets that represent at least a portion of a company's innovation potential—and thus reflect on the companies resilience towards disruption and its ability to build and maintain a competitive position—which is understated on corporate balance sheets.

This first contribution addresses the impact of patents on corporate success, and how this impact can be quantified in a standardized and objective manner from an external perspective with as little information as possible required from the asset owner.

### SUMMARY OF THE INVENTION

Patents are industrial property rights protecting and promoting technical innovation. Compared to other innovation assets, granted patents offer a good starting position for quantification, as they are examined assets. This means that a patent examiner has carefully reviewed the prerequisites for grant—including novelty and inventiveness (two key elements of innovation)—and found them to be met.

The relationship between the number and/or quality of patents owned by a company and its innovative capacity has been examined from various perspectives in the scientific community. While the extent of their relevance varies on a case-by-case basis and is dependent on the technology that the patent(s) relate(s) to, it is undisputed that patents are contributing to corporate success. These contributions can be of many kinds. For example: Defensive, when a patent offers its owner a blocking or defensive position, protecting revenue streams or providing freedom-to-operate for the owner's product roadmap; offensive, when a patent offers its owner opportunities to attack the products and services of competitors and (at least temporarily) have them excluded from the market; transactional: when the patent owner sells a patent or relinquishes its exclusivity in favor of the monetary returns yielded by means of a licensing program.

In addition, there are other use case that are currently only pursued to a limited extent in practice, such as security assignments. Of course, several of the business contributions of a patent listed above by way of example can exist in parallel and are not mutually exclusive. This short list, however, already shows that not all of a patent's contributions can be measured directly in cash, in fact many underlying considerations are non-cash considerations.

The obvious solution, as in other areas of economic activity, is to unpack all non-cash considerations, normalize them to a monetary amount, and thus quantify them. In contrast to other economic goods, patents, however, have three peculiarities that make their evaluation, and subsequently their valuation, challenging: Patents are by definition unique due to the prohibition of double patenting and therefore difficult to compare with a peer group. Patents are deliberately formulated in an abstract manner so that they cover as large a scope of protection as possible. Patents are territorially limited, i.e. their territorial scope does not necessarily coincide with the territorial coverage of the relevant product market. Against this background, patent evaluation and valuation typically require an individual expert assessment, which takes time and triggers discovery costs—making the undertaking expensive and slow. This array of potential obstacles are seen as keeping the patent asset class from unfolding its true potential on company balance sheet.

Being able to assign a minimum value to granted patents at scale and in a standardized manner is a crucial enabler for an array of new perspectives on a century-old asset class. The corporate R&D expenditures can be compared to the value generated by the patents sourced in parallel to products being developed—potentially increasing the return-on-investment (“ROI”) for R&D efforts and preventing a “‘Wild West’ when it comes to accounting treatment”.

Further, the expenditures for creating and maintaining a patent portfolio can be compared to the minimum output value of the aggregate patent portfolio, incentivizing the increase of intellectual property budgets where value is created. Having access to such new performance metrics provides interesting new insights into the performance of companies that are active in technology-intensive markets. Fast-performing and reliable innovation indicators derived from readily available financial data and combined with batch-assessment of patent quality can potentially point out under or overvalued stock and show opportunities that are currently hidden in the intangibles section of the balance sheet.

The market need for more transparency in patent valuation was already voiced in a survey undertaken between March and May 2013 by the Expert Group on Intellectual Property Valuation on behalf of the European Commission. While the respondents from the industry sector criticized current IP valuation practice as “too complex”, the respondents from the financial sector “especially mentioned a lack of transparency of current IP valuations” while others pointed to “high valuation costs”.

Today, patent value is typically determined only occasionally and by specialized individuals or teams. Current valuation use cases are, e.g., when taking tax planning decisions (transfer pricing); in cases of mergers, joint ventures, and acquisition; when selling a patent, patent family, or patent portfolio; and in legal disputes by court-appointed experts (especially for damages).

But even these use cases for patent valuations are comparably rare. Going back to the survey undertaken by the European Commission's Expert Group, more than 80% of the respondents in the industry sector reported that “there is hardly any current IP valuation practice” and that—if any—valuations referred to “qualitative valuations”; only one company in the target group conducted monetary valuations. According to the respondents in the finance sector, there was “no IP valuation method that is commonly used within financial institutions”, “none of the respective companies has dedicated IP experts” and “that their firm accountants are familiar with the existing IAs [Intangible Assets], although these IAs are mainly attributed to goodwill”. Even though the survey undertaken by the Expert Group was not representative, it validates two core assumptions: An overwhelmingly large portion of the world's 16 million active granted patents never undergoes any quantitative valuation process despite the fact that the total global value of intangible assets is estimated at around 90% of the business value (and estimated by some at a current aggregate value of USD 75 trillion, predicting USD 1 quadrillion by 2050); and the detected lack of transparency is not based any sort of lacking interest from the financial sector but rather originates in the complexity of the subject matter and the difficulties to standardize and scale current valuation approaches.

There are several established approaches for patent valuation that can be grouped into three dogmatic groups—market-based approaches, cost-based approaches, and income-based approaches. Within each approach several valuation methods can be applied, as presented in the following Table 1:

TABLE 1
Sub-Categories of Valuation Approaches. In practice, combinations
of these approaches can be used to approximate value and to
cross-check findings as all mentioned approaches come with limitations
and can be difficult to apply in individual cases as they often
rely very heavily on subjective factors and data being provided
by the owner of the asset under review.

| | Market | Cost | Income |
|---|---|---|---|
| | Approach | Approach | Approach |
| Method | Active | Reproduction | Discounted |
| | Market Price | Cost | Cash Flow |
| | Analogous | Replacement | Relief from |
| | Method | Cost | Royalty |
| | | | Excess Profit |
| | | | Premium |
| | | | Pricing |

Market-based valuation looks at comparable market transactions, of similar assets to arrive at conclusions of value. One of the core limitations of this approach is the detection of comparable license agreements. Firstly, detailed transaction data is often limited as only a small portion of patents transact throughout their lifetime, and the transaction data varies by industry and territory. Secondly, patents are, by definition, unique assets, making it difficult to derive granular conclusions from transactions even in the same markets. Also, patents are rarely transacted individually which increases the effort to point to one specific portion of the revenues and attribute it to a single asset—especially if non-cash considerations were included in the pricing.

For the above reasons, valuing intangible assets through a direct application of the market approach is not typically possible. Market-based data may, however, be used as inputs into an income approach valuation analysis. For example, when royalty rates for licensing agreements are available this market data can be an input for an income-based valuation. Thus, when market-based data is available, the market approach and income approach can be used in combination.

Cost-based valuation takes into consideration both how much it cost to create the asset historically and how much it would cost to recreate it given current rates. This approach has two major limitations: It is difficult to define exactly which costs can be attributed to the specific asset; and incurred costs in the development of an asset are not directly linked to the potential revenues that the asset can bring to the company. In addition, cost-based valuations require access to a lot of confidential, company-internal data points that are hard—if not impossible—to estimate from the outside. For these reasons the valuation of patents using the cost approach has very limited use and is typically restricted to verifying minimum price thresholds.

Income-based valuation looks at the stream of income attributable to the intellectual property based on the historical earnings and expected future earnings. The value of the asset is considered to be the sum of the present value of the future cash flows (Discounted Cash Flows) that can be generated as of the day of valuation from the use of the intangible asset within its expected economic useful life.

Income-based valuation methods are the most used for IP valuation given the flexibility and the availability of information to obtain a value estimation. They are commonly considered being superior to other valuation approaches. Within the income valuation approach the most commonly used method for patent valuation is the relief-from-royalty methodology. This methodology quantifies the value of an asset by estimating hypothetical royalty payments for the use of an asset. The relief from royalty method calculates the present value of the after-tax royalty savings created by owning the asset. Cost savings in the form of a royalty payment are typically based on a percent of revenue or profit. Actual licensing agreements for comparable assets can be found in SEC filings and other publicly available databases, thus, this method combines market data with the income approach eliminating some of the subjectivity in the market-based valuation model. One of the key limitations of the income-based approaches is that the flexibility of available information, especially individual discount data, leads to heterogenous valuations given that many input parameters rely on patent-specific factors. Applied inconsistently, income-based approaches can lead to a large bandwidth of potential valuation results.

As can be taken from the above, the different established valuation approaches vary largely in their angle of assessment, the key metrics that they are based on, and the amount of data that needs to be provided by the asset owner. As a result, the valuation results can vary significantly based on the selected valuation approach and the accessed data points. As mentioned above, the complexity and lack of transparency were criticized by the respondents to the EU survey on valuation arise with regard to the valuation of patents. To tap into the financial potential of innovation assets, it is crucial to establish a basic valuation approach that is reliable across many industries and jurisdictions, is based on readily available datapoints requiring as little information from the asset owner to ensure that the assessment can be undertaken quickly and objectively, takes the specific patent metrics per industry and jurisdiction into account, and is highly automated to cut down on delivery times and costs. The short-term goal of such approach should not be confused as providing valuations that aim to replace the human expert assessment for their current standard use cases. Rather, it is to shed some light on the quantified potential of the vast majority of patents that are never assessed under the current market realities.

The present invention is a method for estimating the profits generated by patents based on existing industry financial and patent data, in order to minimize the subjective analysis involved in manual income-based patent valuation and therefore bringing a large degree of transparency and standardization to patent valuation. The approach discussed hereinafter has been tested and productized by the authors into a fully automated Patent Valuation Module accessible as a webservice or through application programming interfaces (APIs). The following elaborations should be understood as work in progress, as a commitment to transparency towards the public, and as an invitation to provide constructive feedback to refine the model with the aim of making patent valuation easier to consume for all relevant stakeholders. Our Patent Valuation Module integrates patent and financial data from multiple data sources in a relief from royalty valuation model. By automatically feeding the model and applying a uniform qualitative standard of assessments to all valued patents, it eliminates the inherent subjectivity associated to income-based valuations.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIG. 1 is a chart showing the transposition of prior art proximity scores.

FIG. 2 is a table showing discount rate windows.

FIG. 3 is a chart showing the discount rate windows for the Patent Valuation Module

FIG. 4 is a chart of the Risk Matrix for the Patent Valuation Module.

### DETAILED DESCRIPTION OF THE PREFERRED EMBODIMENT

The present invention is a method for estimating the profits generated by patents based on existing industry financial and patent data, in order to minimize the subjective analysis involved in manual income-based patent valuation and therefore bringing a large degree of transparency and standardization to patent valuation. The approach discussed hereinafter has been tested and productized by the authors into a fully automated Patent Valuation Module accessible as a webservice or through application programming interfaces (APIs). The following elaborations should be understood as work in progress, as a commitment to transparency towards the public, and as an invitation to provide constructive feedback to refine the model with the aim of making patent valuation easier to consume for all relevant stakeholders. Our Patent Valuation Module integrates patent and financial data from multiple data sources in a relief from royalty valuation model. By automatically feeding the model and applying a uniform qualitative standard of assessments to all valued patents, it eliminates the inherent subjectivity associated to income-based valuations.

The steps to carry out the valuation are the same steps carried out in a traditional relief from royalty valuation model; the core innovation comes from pre-aggregating cleaned and normalized data in the model so as the only input parameter required to carry out the valuation is the target patent number.

Based on this target patent number, the algorithm carries out the following steps automatically to obtain a sophisticated economic valuation of the target patent: Extracting the input patent data; mapping of the target patent to a specific target market; performing qualitative analysis on the target patent and its peer group to evaluate core patent metrics; calculating the remaining useful life of the target patent and its peer group; forecasting of the expected revenues and annual growth rates attributable to the target patent over its useful life; selecting an applicable royalty rate based on market data; applying an appropriate tax rate to obtain the after-tax royalty savings; and applying an appropriate risk-adjusted discount rate to discount the resulting revenue streams to present value. To increase the processing speed per request, many—preferably all—of these steps can be precomputed and updated periodically. At the same time, some of the mentioned steps can be executed in parallel.

Based on the submitted target patent number, at least the following data is extracted from the patent database to carry out the valuation: As mentioned in the introduction of the patent assets, granted patents are interesting for quantification as their underlying technical teaching was found to be novel and inventive by a patent examiner. Pending patent applications are pending examiner review. Thus, the algorithm needs to take a further factor into account when assessing pending applications: the likeliness to grant. Accordingly, the kind code of the target patent is used to determine which standard of assessment applies.

The legal status for the target asset is summarized to the states “active” or “inactive”. While recently expired patents can still have a remaining value incorporated in claims to damages for acts of patent infringement during a patent's lifetime, inactive patents typically do not have remaining attributable cashflows and should be, preferably are (as in the Patent Valuation Module), not eligible for an income-based valuation.

Patents are territorial property rights. As such, they are closely connected to a specific territory—their country of origin. The country code of the target patent is used to determine the target territory. This involves the decomposition of regional or supranational filings into their respective territories, e.g. for European Patents granted under the European Patent Convention (EPC).

Another important datapoint for the determination of the relevant industry that the target patent relates to are the patent classification codes. Patent classification codes are used for organizing all patent documents into specific technology groupings based on common subject matter. While some patent offices apply the International Patent Classification (IPC) methodology, a large range of patent offices follow the Cooperative Patent Classification (CPC) system, a jointly developed system with the European Patent Office (EPO). To obtain a homogenous dataset, it is important normalize the classification data to one patent classification scheme. The Patent Valuation Module uses the CPC system.

The filing date is extracted to compute the remaining lifetime of the target patent. The patent text (especially the claim text) of the target patent is extracted to perform the qualitative analysis in the evaluation step of the valuation process.

Based on the extracted CPC information, the target patent can be assigned to a specific industry.

Using classification data for industry mapping is a common approach to break large numbers of patents down into technology clusters based on their subject matter. To map to industries, it is necessary to come up with a proprietary, or to select an existing, target industry classification scheme in a first step. A range of industry classifications are used in different contexts around the world, e.g. the North American Industrial Classification System (NAICS), the General Industry Classification System (GICS), the Standard Industry Classification system (SIC), the Worldscope Industry Group System (WSIG), the Dow Jones Global Classification System (DJGCS), the Revere Business Industry Classification System (RBICS), the Classification for National Economic Activities (for industries in China), and the Industrial Classification Benchmark (ICB).

We have tested various approaches to map patent classification data to various industry taxonomies and found that the CPC system maps very well to the North American Industrial Classification System (NAICS), the General Industry Classification System (GICS), and the Revere Business Industry Classification System (RBICS).

Patent-to-Industry mapping can be achieved by hard assignments (only one industry is determined per target patent) or soft assignments (multiple industries are determined per target patent).

To investigate which approach produces the best results, we have analyzed the co-occurrence of primary CPC classes with additional CPC classes across a dataset of more than 51 million patent documents. The study revealed which CPC classes typically co-occur at what hierarchical level, and that there is little noise in the dataset when it comes to the detection of outliers if a high CPC group level is selected. At the same time, the risk of misclassification, i.e. human error, is reduced in higher CPC group levels compared to more granular CPC group levels. Based on these findings, we opted for a hard assignment approach for the mapping of primary industry. For the detection of secondary industries, we then considered soft assignments as patents within the same primary industry more often relate to more than one secondary industry.

In full awareness that the patent subject matter can relate to more than one primary industry in cases of cross-industry relevance as technology areas converge (e.g. financial software), and to mitigate potential risks sparked by misclassifications, we have carefully constructed a balanced system for the allocation of revenues as will be further elaborated. The patent-to-industry mapping enables the algorithm to join financial data for the target market (being the combination of country and industry) with patent data for the target market. The following parameters are then looked up and/or computed for the target market: M is the total sales volume of the target market expressed in a currency (e.g. USD). The volume is computed based on the aggregate annual net sales reported for the target market. R is the total volume of R&D expenditures on the target market expressed in a currency. The volume is computed based on the aggregate annual R&D expenditures of all companies in the target market. N is the total number of active patents in the target market. This group is the peer group for the relative quality assessment of the target patent as will be pointed out in Section V.3. in more detail. The CAGR is the target market 5 year compound annual growth rate expressed in percent. The CAGR can be computed for the aggregate sales (M), the aggregate R&D expenditures (R), and the number of active patents (N).

Having established its target market for the target patent and its peer group, a qualitative assessment of the target patent and each single of its peers follows. This step is a core differentiator of a patent valuation approach using exponential technologies over manual valuation approaches. While manual approaches, if at all, review the qualitative metrics of the target patent, the relevant peer group (referred to as comparable or the relevant universe of patents) does typically not undergo any qualitative assessment. Using the approach described in this paper, all patents are held to the same standard of assessment. Automated review can, admittedly, not compete with manual review by a human expert in terms of accuracy—but automated review is unmatched when it comes to speed and cost. The advances in the field of text mining, summarization, and comparison over the last decade have enabled a completely new perspective (at an acceptable accuracy rate) on patent quality that was simply not possible before.

The automated qualitative assessment considers two key factors: patent quality and prior art proximity. “Patent quality” is a term often used, but there is no agreed upon definition or metrics to establish patent quality. It is often focused on the assessments of a patent's validity prospects but some researchers point to additional qualitative “indicators”.

The automated assessment underlying the valuation concept presented differentiates expressly between the assessment of validity and the assessment of additional qualitative indicators. Of course, it is well-understood that the validity prospects of the target patents are the most fundamental aspect for both the monetary value of a target patent (invalid patents do not have a market value) and the determination of the risk-adjusted discount rate But the goal of breaking out a separate quality score is to capture various aspects related to how well the invention is described, its pioneering nature, its market/commercial importance and significance, and how relevant it is for technologies that are currently being actively developed and deployed.

The patent quality score (0-100) is computed for each patent (for the target patent and for every peer in the target market). It is designed to measure its overall quality relative to the full collection of patents. The idea behind the approach is to imitate the process that an expert would follow when asked to identify the set of the most important patents related to one or more patents describing a particular technology, i.e. by undertaking a citation analysis, considering the respective patent family size, reviewing the assignment history, and considering by how well their claims are supported by the specification. The process is operationalized by using a random-walk-with-restart (RWR), which is a stochastic process on networks (graphs), and in its simplest form computes for each network node the steady state probability that a random walker will end up on that node. Nodes with high steady-state probabilities correspond to central nodes and depending on the underlying domain, they correspond to topical authorities. The model used in the Patent Valuation Module employs a novel RWR model, referred to as expert-random-walker-with-restart (ERWR) which was specifically developed for patent analysis and is rationally designed to model the expert's process using RWR as applied to patents. The goal of this single score is to capture various aspects related to how well the invention is described, its pioneering nature, it market/commercial importance and significance, and how relevant it is for technologies that are currently being actively developed and deployed. In the Patent Valuation Module, the quality score is currently determined for each patent.

Patent “validity” is a legal term encompassing more than just a novelty and inventiveness/non-obviousness assessment. The automated assessment used in the Patent Valuation Module is a text-based proximity comparison and should therefore be called a prior art proximity assessment. For the purpose of the evaluation, each claim of a patent is considered separately on an element-by-element basis (a process referred to as segmentation). This allows an assessment from two different angles: on a claim-by-claim basis and on a claim element-by-claim element basis. To do so, a network is constructed that consists of two types of nodes: (i) the art node (patents and non-patent literature), and (ii) the classes of the patent classification node. Each art node is linked to all the art nodes that it cites and is linked to all the classification nodes to which it belongs. The weights of the first set of edges are determined based on the content similarity of the corresponding art nodes whereas the weights of the second set of edges are determined based on the classification strength. If the art corresponds to patents and/or patent applications, their known classifications are used (the primary class has higher weight than secondary classes). By leveraging the citation network, the classification hierarchy and the connections between art and classifications, prior art is detected that is highly related to the target patent, and that humans directly or indirectly determined to be relevant. This same approach is used when evaluating motivations to combine. If patents are ranked high in the random walk seeded on the target patent, then there is strong evidence that an expert should have been aware of these different pieces of prior art and as such should have thought of combining them.

The raw prior art proximity determined by the approach described above is expressed as a score (0-100) and computed for each patent (for the target patent and for every peer in the target market). It is noteworthy that the raw prior art proximity score should not be used without additional consideration. Otherwise, a unique characteristic of patents would not be taken into account: High raw prior art proximity scores evidence that the first independent claim of the target patent is very unlikely to be anticipated by prior art publications (i.e. there is a long range between the closest prior art documents and the target patent's claim). Low raw prior art proximity scores in turn evidence that the first independent claim of the target patent is very likely to be anticipated by prior art publications (i.e. there is a short range between many close prior art documents and the target patent's claim). Accordingly, patent claims with many limiting segments benefit from high scores while patent claims with few segments obtain from low scores. However, the more limiting segments a claim has, the smaller is its scope of protection (and the easier it is to build products or offer services that do not infringe the claim). Therefore, it is crucial for a claim to strike the right balance between the broadest possible scope of protection and the distance from the closest prior art.

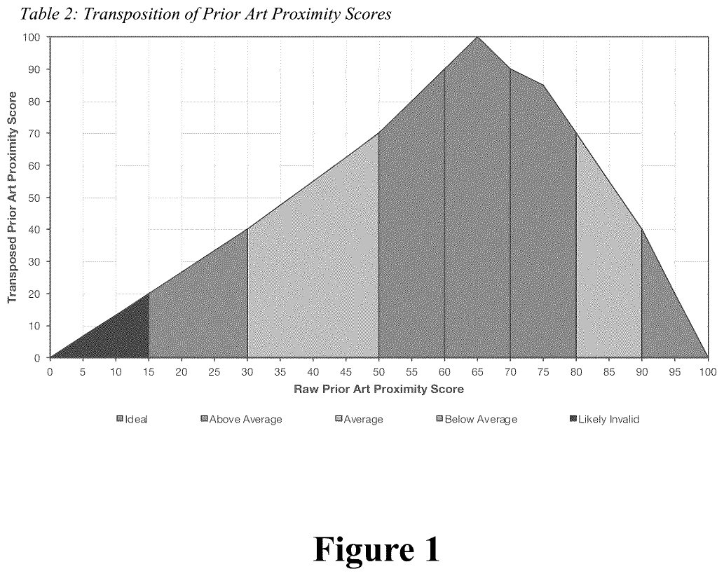

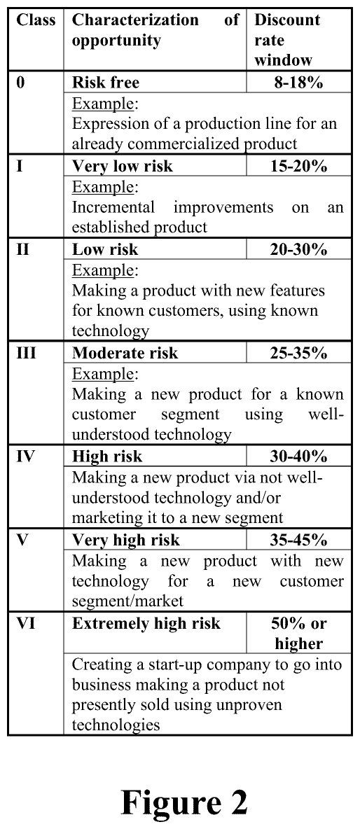

FIG. 1 is a chart showing the transposition of prior art proximity scores. To take these circumstances adequately into account, the raw prior art proximity scores are transposed for the Patent Valuation Module as shown in FIG. 2. Patents that score lower than 15% on their raw Prior Art Proximity Score are very likely invalid and therefore not considered in the Patent Valuation Module, i.e. if the target patent scores a raw Prior Art Proximity Score below 15%, the Patent Valuation Module returns a patent value of 0. By computing quality scores and prior art proximity scores for every single relevant patent, an unrivaled qualitative insight into the target market is provided. The granularity of the assessment provides new parameters like the average quality score per target market, the average prior art proximity score per target market, and allows a quality-based ranking of individual patents. For the Patent Valuation Model, the following scores are pre-aggregated and updated periodically to reduce the runtime per query: the quality score for each active granted patent in the database; the prior art proximity score for each active granted patent in the database; the average quality score for each potential target market; the average prior art proximity score for each target market.

For the valuation of patents, the determination of the useful life needs to strike the balance between the maximum period of protection (20 years) and the technology obsolescence rates per respective market. A strong indicator for the useful life of patents is to analyze statistically how long the owners of granted patents are willing to pay the annual fees to the patent office to maintain their patents (so called drop rates). An at-scale assessment showed that drop rates correlate with technology obsolescence rates, i.e. the large majority of patents tend to lapse before (in some countries and industries significantly earlier) they reach their maximum term of protection. To get even closer insights into the timeframes wherein granted patents unfold their full potential (patents only convey exclusivity to their owners after the grant), the time between the publication of the patent grant and its actual expiration date can be measured. For the Patent Valuation Model, the average useful life per target market is pre-aggregated and updated periodically. It is currently calculated by measuring the time between the filing dates and the actual expiration dates of each granted patent per target market over a time period of 20 years.

In the valuation workflow according to the Patent Valuation Model, the current age and the remaining maximum lifetime of the target patent is determined in a first step. The current age is the distance between the filing date and the date of the valuation. The remaining maximum lifetime is the distance between the date of the valuation and twenty years after the filing date of the target patent. In a second step, the current age of the target patent is compared to the pre-computed average useful life of its peer group in the target market. If the age of the target patents is below the average useful life for the target market, the time span between the current age and the point in time at which the target patent would lapse if it were maintained until the average useful life in the target market is reached, is set as the remaining useful life. If the age of the patent is already above the average useful life for the target market, then the remaining maximum lifetime is used as a proxy and set as the remaining useful life of the target patent.

To attribute revenues to the target patent, a sophisticated top-down approach is used based on the input variables extracted in step 2. The importance of technical innovation varies from industry to industry. While the ability to innovate is essential in research-heavy industries (like the pharmaceutical industry and the semiconductor industry), it is less important in many industries that are focused on retail and on services. Accordingly, not the full aggregate annual sales volume per target market should be used as the reference point for the patent valuation. Rather, it is necessary to determine how relevant the amount of annual R&D expenditures and the number of active patents per target market are for yielding the aggregate sales, i.e. the “shadow” or “footprint” patents have on sales—the Patent Intensity Ratio (PI).

There are many proposals as to how to measure the relevance of R&D and patent counts for business success per industry. The algorithm proposed in this paper also approaches the patent intensity measurement by analyzing the effect that the number of patents has over the R&D expenditure within the industry relative to all other primary industries in the same country. The Patent Intensity Ratio is calculated by analyzing the inverse correlation between the normalized patent percentile of an industry with the normalized R&D/patent percentile of the industry. If an inverse correlation exists between the Number of patents and the R&D expenditure per patent, we can conclude that the industry is patent intensive. However, if this inverse correlation does not exist it means that R&D expenditure is not directed towards patents, thus the patent intensity is low. This Patent Intensity Ratio is a good indicator of the perceived strategic value of patents within specific industries, either because high R&D expenditure is directed towards obtaining a limited number of patents (=high R&D/patent percentile & low patent number percentile) or because the main output of the R&D expenditure are patents (=low R&D/patent percentile & high patent number percentile). The first step for the determination of Patent Intensity Ratios in a country is to calculate the average annual R&D expenditure per active patent for each primary industry in the target country. This is achieved by simply dividing the aggregate annual R&D expenditures of all companies in the target market (R) by the total number of active granted patents in the target market (N):

R&D/Patent($)=R($)/N($)

Once the R&D per patent expenditures are calculated per industry in a country, the values are assessed in relative comparison to each other to understand how each industry is positioned. This is done by Z-score normalization in a first step, and by converting the determined Z-scores into percentiles based on the cumulative distribution in a second step. The same approach is followed with regard to the patent numbers per target market (N). Z-score normalization is applied to the aggregate active patents per industry in a country, and the Z-scores are converted into percentiles based on the cumulative distribution. The Patent Intensity Ratio is then calculated as the absolute value of the difference between the number of patents percentile and the R&D per patent percentile. The bigger the difference between these two percentiles, the bigger the effect of patents over R&D expenditure, thus the higher the patent intensity and the perceived strategic value of patents within the industry. This approach allows the model to reduce the total market size (M) by a percentage that is proportional to the perceived strategic relevance of patents within the target market for the annual sales volume in the target market. Once the Patent Intensity Ratio (PI) is calculated, the market size attributable to all patents in the target market (MPi) is computed by multiplying the total market size (M) by the Patent Intensity Ratio (PI):

MPi($)=M($)×PI(%)

Having established the market size attributable to all patents in the target market (MPi), revenue shares need to be assigned to each individual patent. A linear assignment by dividing the market size attributable to all patents in the target market (MPi) by the total number of granted active patents in the target market (N) is out of the question as such assessment would not reflect the individual patent quality at all. The assessment of potential new avenues based on the new perspectives on patent quality through batch-assessment has revealed two interesting alternatives: According to a first approach, the market size attributable to all patents in the target market (MPi) is allocated considering the quality and prior art proximity scores. The goal is to assign higher revenues to high scoring patents and low revenues to low scoring patents—in a way that the sum of all revenues attributable to the active patents in a target market (ri) equals the total market attributable to patents.

$${\sum }_{1}^{N} r i = M P i$$

According to this first approach, the average quality and prior art proximity scores determined for the target market pursuant to Section V.3. are used. Providing equal weight to each of the scores, an overall average Patent Score (S) is obtained as the mean of both the quality score and the prior art proximity score. The average Patent Score (OS) is calculated for all active patents in the target market and as an individual Patent Score for the target patent (si). Taking the overall average score for the industry (OS) and the target patent score (si) into consideration the total revenues attributed to the target patent (ri) are the following based on the first approach:

$$r i = \frac{MPi \times si}{N \times ∅ S}$$

One potential limitation of the first approach is that it is highly dependent on the industry mapping for the target patent. As elaborated in Section V.2., the industry is derived based on the target patent's industry classification following a hard assignment. The inherent risk of hard assignments is that patents with cross-industry relevance and misclassified patents can differ widely in their value based on the selected industry (see above, Section V.2.c). To mitigate these risks and to attribute for the general convergence of industries in the software, electronics, communications, and semiconductor space, a second cross-industry allocation approach was modelled and tested. According to this second approach, all market sizes per industry (MPi) are aggregated into a total patent market on the country level (MPt). Thus, the total patent market (MPt) represents the total annual volume of sales attributable to patents for a specific country. The same is done for the total numbers of granted active patents per industry (N) into the total number of granted active patents for said specific country (Nt). Subsequently, the mean revenue per granted active patent in the target country (ØrC) is calculated for said specific country by dividing the total patent market (MPt) by the total active patent count (Nt).

ØrC(S)=MPt($)/Nt(#)

The mean revenue per granted active patent (ØrC) serves as a reference value for the further assessment. However, it must be taken into account that the different industries in the country have contributed differently to the total patent market (MPt); on the one hand, because the industries generate different annual sales (M) and, on the other hand, because the Patent Intensity Ratios (PI) per industry are individual. To be respectful of this setting, the contribution ratio (CRi) of each industry in the target country to the total patent market (MPt) is calculated in a first step by dividing the determined patent markets (MPi) by the total patent market (MPt).

CRi(%)=MPi($)/MPt($)

In a second step, Z-score normalization is applied across all contribution ratios (CRi) for the target country (%). All active patent counts (N) per industry in the target country also undergo a Z-score normalization (%). In doing so, the relationships between the contribution ratios and the active patent numbers are assessed vis-a-vis each other and made comparable. Providing equal weight to each of the determined percentual Z-scores per industry in the target country, an overall average Industry Relevance ratio (IR) is determined per industry in the target country. The Industry Relevance ratio (IR) can be positive or negative. Finally, the Industry Relevance ratio (IR) is multiplied by the mean revenue per granted active patent (ØrC) in the target country. The result is the mean revenue per granted active patent in the target market (ØrM). Having determined the mean revenue per granted active patent in the target market (ØrM), the individual revenue share of the target patent (ri) needs to be derived. As in Approach 1, the individual Patent Score (si) and the overall average Patent Score for the industry (ØS) are calculated to determine the annual growth rate after 5 years (see Section V.5.d.) and to provide an individual boost or discount (%) for the target patent's qualitative performance relative to its peer group:

br=si/ØS

This ratio (br) is then applied to the mean revenue per granted active patent in the target market (ØrM) to obtain the total revenues attributed to the target patent (ri).

ri=br×ØrM

Approach 2 accounts for the (increasing) footprint of cross-industry technology while the largest part of the attributable revenues originate from the target patent's target market. The methodology of Approach 2 is therefore currently applied in the Patent Valuation Module. Once the revenues associated to the target patent (ri($)) are calculated, the aggregate revenues over the target patent's remaining useful life can be predicted by applying the target industry 5 year CAGR obtained from financial data for the first five years, and an annual growth rate between 1,5% and 2,0% for the remaining years depending on whether the target patent's score (si) was above or below the industry average S (OS). The growth rate is expressed as G.

To obtain the applicable royalty rates the Patent Valuation Module uses target industry market data for patent licensing transactions using net sales (revenues) as the royalty rate. This information is readily available in proprietary royalty rate databases that integrate publicly disclosed transactions, and in additional resources. By multiplying the revenues associated to the target patent (ri) by the applicable royalty rate (Roy), the pre-tax royalty savings for the target patent (Rsi(Pre-tax)) are obtained:

Rsi(Pre-tax)($)=ri($)X Roy(%)

In the relief from royalty valuation methodology the annual after-tax royalty savings are computed and then discounted to present value using an appropriate discount factor. To calculate the after-tax royalty savings, we subtract the applicable corporate tax associated to the pre-tax royalty savings. To carry out this step the applicable corporate tax (T) for the target patent jurisdiction is ingested into a lookup table for the Patent Valuation Module. This information is available publicly. The after-tax royalty savings (Rsi) for the target patent are then calculated as follows:

Rsi($)=Rs(Pre-Tax)X(1−T)

The final step to compute all the variables required for the relief-from-royalty valuation methodology is to obtain an appropriate risk-adjusted discount rate to discount the resulting revenue streams to present value. Discount factors for valuation of certain assets are usually computed using the weighted average cost of capital (WACC) and Capital Asset Pricing Methodology (CAPM), adjusting for asset-specific risks by adding risk adjusted hurdle rates. While this methodology could be applied on a case-by case basis, it is not feasible for the valuation of all patents as the capital structure for individual patent owners varies largely—and this is not necessarily linked to an individual patent value. Discount factors used by the Patent Valuation Module are based on the overall risk that can be attributed to the investment in the patent by characterizing the risk through a qualitative risk matrix using the obtained quality score and prior art proximity score as a basis.

FIG. 2 is a table showing discount rate windows. Before the mapping to the risk matrix is performed, the discount factor considers the litigation intensity in the target patent's industry to reassess the obtained prior art proximity score. While the prior art proximity of a patent is an abstract inherent validity risk, this abstract risk is increasingly likely to be put to the test in the course of litigation. The invalidation likeliness increases and decreases with the litigation intensity rates. Therefore, adjustments to the obtained prior art proximity score are required. For the Patent Valuation Module, the litigation rates were determined by reviewing more than 80,000 global litigation data sets over a period of 10 years (2006 to 2016) and by determining the industry of each patent in suit as described in Section V.2. Based on the public case counts, the litigation intensity can be determined per industry based on the average annual new litigation cases as analyzed over the 10-year period (#). Currently, the Patent Valuation Module applies global litigation intensity rates but as more data becomes available, the litigation intensity can be determined per target country and industry.

Z-score normalization is applied to the average annual number of litigation cases per industry (preferably per country), and the Z-scores are converted into percentiles based on their cumulative distribution (litigation percentiles (%)). Next, the litigation percentiles are inverse (100%—Litigation percentile). The inverse litigation percentiles are then each averaged with the respective obtained average prior art proximity score per target market at a weight of 1:3 to the favor of the obtained average prior art proximity score. The resulting score is a modified prior art proximity score representative for the target market (Prox-Mod(Target Market)). The percentile increase or decrease of the originally obtained average prior art proximity score for the target market compared to the modified prior art proximity score for the target market is determined—the target market litigation risk adjustment (lit ratio (%)). The target market litigation risk adjustment (lit ratio) is then applied to the obtained individual prior art proximity score of the target patent as an individual risk discount.

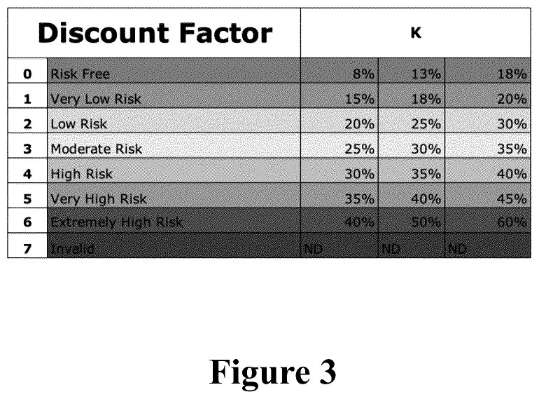

FIG. 3 is a chart showing the discount rate windows for the Patent Valuation Module. The result is a risk adjusted modified prior art proximity score for the target patent. The modified prior art proximity score for the target patent and the originally obtained quality score for the target patent are then mapped to a risk matrix to determine the applicable risk adjustment discount rate (K) for the Patent Valuation Model. The discount factors applied fall within commonly accepted value ranges used in the valuation of patents and other intangible assets, as shown in FIG. 2. One additional risk class is added for patents that are likely invalid (in which the prior art proximity score is below 15%).

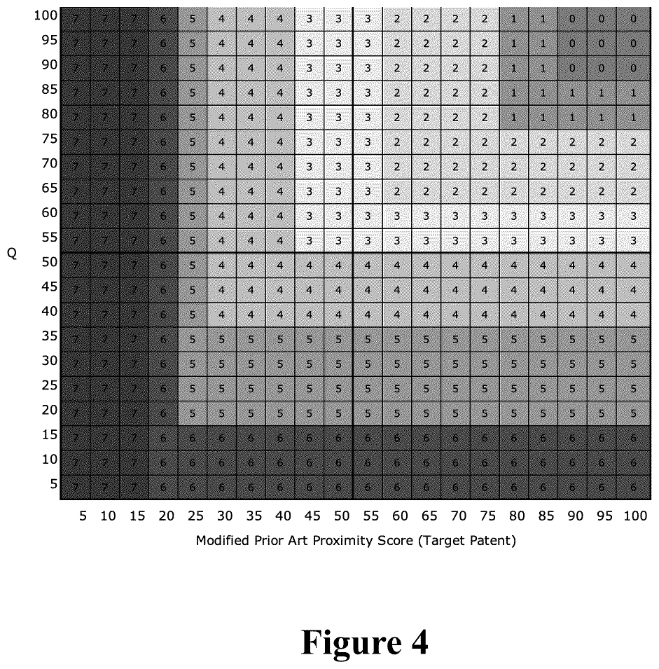

FIG. 4 is a chart of the Risk Matrix for the Patent Valuation Module. The risk matrix as shown in FIG. 4 can be applied to the present invention. Now all the required variables are determined to carry out a valuation through a relief from royalty patent valuation methodology:
Ri=Revenues associated to the target patent at year 1
Roy=Applicable royalty rate
UL=Remaining useful life of the target patent
G=Annual growth rates associated to the target patent throughout its useful life
T=Applicable tax rate
K=Risk-adjusted discount factor

The present value of the after-tax royalty savings associated to the patent throughout its useful life are calculated by applying the present value formula. The formulas to be computed in a standard valuation model would be the following:

MPi($)=M($)×PI(%)

ri=br(Target Patent)×ØrM

Ri+1=Ri×(1+G)

Rsi(Pre-tax)($)=ri($)X Roy(%)

Rsi($)=Rs(Pre-Tax)X(1−T)

$${\sum }_{i = 1}^{i = U L} \frac{R s i}{{( 1 + K )}^{i}} = Present Value of Patent$$

Where:
M=Total Market Size of the target market
PI=Patent Intensity Ratio associated to the industry within patent jurisdiction
MPi=Market size associated to patents in the target market
br(Target Patent)=Individual boost or discount for the target patent's qualitative
performance relative to its peer group.
ØrM=Mean revenue per granted active patent in the target market
Rsi(Pre-tax)=Pre-tax royalty savings for the target patent
Rsi=After-Tax royalty savings associated to the target patent at year 1

The valuation model disclosed herein and as it is implemented in the Patent Valuation Module is an initial solution to provide new perspectives on an intangible asset that is rarely valued at scale. Accordingly, the new valuation approach will eventually bring transparency to the patent market and is a first step on the mission to measure and boost patent utilization rates. Additional valuation summaries can be obtained by calculating patent family values, portfolio values, and the value of patent clusters. Within the IPwe Platform, the valuation results will be validated through real patent transactions. This validation will feed the algorithm with market data that will improve the quality of results. This will create a data network effect through machine learning, that has the potential solve many of the inefficiencies in today's patent market that limit investment in patents as an asset class.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A system for a patent valuation module, comprising:
An application programming interface;
An algorithm that can automatically obtain an economic valuation of a target patent by:
extracting the input patent data;
mapping of the target patent to a specific target market; performing qualitative analysis on the target patent and its peer group to evaluate core patent metrics;
calculating the remaining useful life of the target patent and its peer group;
forecasting of the expected revenues and annual growth rates attributable to the target patent over its useful life;
selecting an applicable royalty rate based on market data; applying an appropriate tax rate to obtain the after-tax royalty savings; and
applying an appropriate risk-adjusted discount rate to discount the resulting revenue streams to present value.
